(19) United States
(12) Patent Application Publication
(10) Pub. No.: US 2010/0073250 A1
(43) Pub. Date: Mar. 25, 2010

(54) ANTENNA DEVICE

(75) Inventors: Wataru Noguchi, Osaka (JP); Hiroyuki Yurugi, Osaka (JP); Toshihiro Ezaki, Osaka (JP); Masaaki Higashida, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/447,302

(22) PCT Filed: Oct. 29, 2007
(86) PCT No.: PCT/JP2007/071064

§ 371 Date: Apr. 27, 2009

(30) Foreign Application Priority Data
Oct. 30, 2006 (JP) P2006-294035

(51) Int. Cl. H01Q 21/29

(52) U.S. Cl. 343/816; 343/810

(57) ABSTRACT

An antenna device provided in a space such as an aircraft, or the like at least a part of which is surrounded with a metal, and used in a radio communication system based on a MIMO system is disclosed. The radio communication system includes a server provided in a ceiling space of a cabin of the aircraft, a connection cable, a plurality of WAPs, and a plurality of client terminals provided near passenger's seats respectively. The antenna device is used as the antennas of WAPs, and has dipole array antenna including a plurality of antennas. The antenna device capable of ensuring a good communication quality even in any location in the space at least a part of which is surrounded with the metal can be provided.

### TECHNICAL FIELD

The present invention relates to an antenna device that is provided in a space at least a part of which is surrounded with a metal, and used in a radio communication system based on the MIMO system.

### BACKGROUND ART

An IFE (In-Flight Entertainment) system denotes such a system that distributes movie, music, game, etc. to passenger's terminals, and the like in a cabin of an aircraft, or the like. In building up the IFE system, a coaxial cable and a server are provided in the ceiling space of the cabin, a client terminal (SEB: Seat Entertainment Box) are provided near the passenger's seats respectively, and the server and the client terminals are connected via the cable using a switching hub, or the like. Since the connection cable must be covered with a protection cover for the purpose of improving durability and fire resistance, such connection cable is heavier than the normal cable and cannot be easily deformed. For this reason, upon changing the arrangement of the passenger seats, it takes much time/labor and cost because the connection cables must be exchanged.

FIG. 1 shows an IFE system utilizing a radio communication. The IFE system shown in FIG. 1 is equipped with a server 11 provided in a ceiling space of a cabin 10, a connection cable 12, a plurality of WAPs (Wireless Access Points) 13, and a plurality of client terminals 14 provided near passenger's seats. The plurality of WAPs 13 are connected to the server 11 via the connection cable. The WAP 13 and the client terminal 14 have a wireless network interface circuit and an antenna (not shown) respectively, and can hold a radio communication utilizing the wireless LAN based on IEEE802.11a, IEEE802.11b, or IEEE802.11g.

The communication system utilizing a plurality of WAPs has such a problem that communication quality is degraded on account of a leakage to adjacent channels or an interference of a reflected wave from the wall or the floor. Therefore, a sending power, a directivity of the antenna, and the arrangement of WAPs must be adjusted. However, it is difficult to adjust these factors in the environment such as the aircraft, or the like, which is surrounded with a metal.

In a broadband wireless distribution system disclosed in JP-T-2006-506899, as shown in FIG. 10, a patch antenna containing four rectangular array elements is utilized as the antenna of WAP. The directivity of the patch antenna shown in FIG. 10 is illustrated in FIG. 11 and FIG. 12 respectively. FIG. 11 shows a directivity on a first vertical plane of the patch antenna, and FIG. 12 shows a directivity on a second vertical plane that intersects orthogonally with the first vertical plane of the patch antenna. In this event, the WAPs are arranged such that the first vertical plane of the patch antenna is provided in the lateral direction of the aircraft and the second vertical plane is provided in the longitudinal direction of the aircraft. Also, as shown in FIG. 13, WAPs are provided on the ceiling space almost just over one aisle out of two rows of aisles in the cabin.

Patent Literature 1: JP-T-2006-506899

Patent Literature 2: US2004/0098745

Patent Literature 3: W02004/047373

### DISCLOSURE OF THE INVENTION

### Problems that the Invention is to Solve

As shown in FIG. 12, the patch antenna explained above has the narrow directivity on the second vertical plane (in the longitudinal direction). Therefore, a radio interference with a signal from the adjacent WAP can be avoided by adjusting the sending power of respective WAPs. In contrast, as shown in FIG. 11, the directivity on the first vertical plane shows a sector shape, but a half-power angle is narrow like about 90 degree. As shown in FIG. 14, in order to make it possible for a radio wave being radiated from the patch antenna of WAP provided on the ceiling space just over one aisle to spread to the most distant seat next the window at sufficient electric field strength, a half-power angle of about 144 degree (72×2) on the first vertical plane is needed. However, actually a half-power angle on the first vertical plane is 90 degree, and therefore the electric field strength received at the seat most distant from WAP and next the window is low.

In order to solve this problem, when a sending power from WAP is increased to increase the electric field strength received around the seat next the window, a radio interference with the signal from the adjacent WAP is caused. Also, as shown in FIG. 15, even when the arrangement of WAPs is changed, a radio interference with the signal from the adjacent WAP is caused.

It is an object of the present invention to provide an antenna device capable of ensuring a good communication quality even in any location in a space at least a part of which is surrounded with a metal.

### Means for Solving the Problems

The present invention provides an antenna device provided in a space at least a part of which is surrounded with a metal and used in a radio communication system based on a MIMO system, the antenna device including a dipole array antenna having a plurality of dipole antennas.

In the antenna device, the dipole array antenna includes three dipole antennas.

The antenna device further includes a distributor which distributes a signal to each of the plurality of dipole antennas. The dipole array antenna and the distributor are provided on a same substrate, and the dipole antennas are provided in vicinity of a ground pattern of the distributor.

In the antenna device, an electrical length from an end of the ground pattern of the distributor to a center of the respective dipole antenna is ¼ wave length.

In the antenna device, the dipole array antenna is non-directional on a first vertical plane, and a pattern indicating a directivity on a second vertical plane that intersects orthogonally with the first vertical plane has an 8-shaped form.

In the antenna device, a pattern indicating a directivity on a first vertical plane of the dipole array antenna has a cardioid shape, and a radiation pattern on a second vertical plane that intersects orthogonally with the first vertical plane has a main lobe extended on a particular direction and has a null point in other directions.

In the antenna device, the space is an internal space of a fuselage of an aircraft.

In the antenna device, the radio communication system includes an access point and a client terminal, and is used as antennas on a side of the access point.

### Advantage of the Invention

According to the antenna device according to the present invention, a good communication quality can be ensured even in any location in the space at least a part of which is surrounded with the metal.

### BRIEF DESCRIPTION OF THE DRAWINGS

FIG. 1 shows an IFE system utilizing a radio communication.

FIG. 2 is a block diagram showing WAP and an antenna device according to a first embodiment of the present invention.

FIG. 3 shows patterns of a three-way distributor and a dipole array antenna that are provided to the antenna device of the first embodiment.

FIG. 4 shows a directivity on a first vertical plane of the antenna device of the first embodiment.

FIG. 5 shows a directivity on a second vertical plane of the antenna device of the first embodiment.

FIG. 6 shows an arrangement in a cabin of an aircraft and WAP and an antenna device.

FIG. 7 shows patterns of a three-way distributor and a dipole array antenna that are provided to the antenna device of a second embodiment.

FIG. 8 shows a directivity on a first vertical plane of the antenna device of the second embodiment.

FIG. 9 shows a directivity on a second vertical plane of the antenna device of the second embodiment.

FIG. 10 shows a patch antenna containing four rectangular array elements.

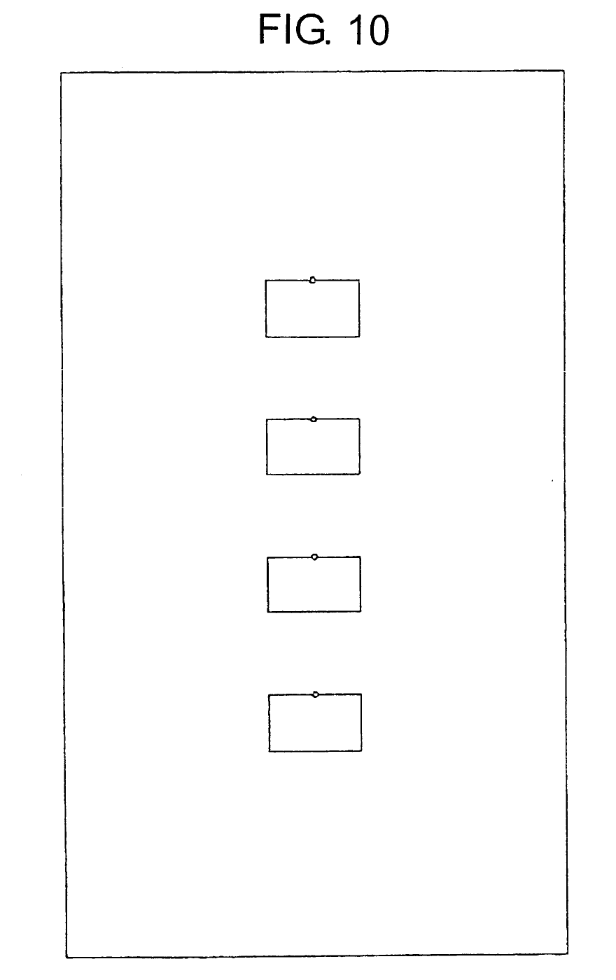

FIG. 11 shows a directivity on a first vertical plane of the patch antenna.

FIG. 12 shows a directivity on a second vertical plane that intersects orthogonally with the first vertical plane of the patch antenna.

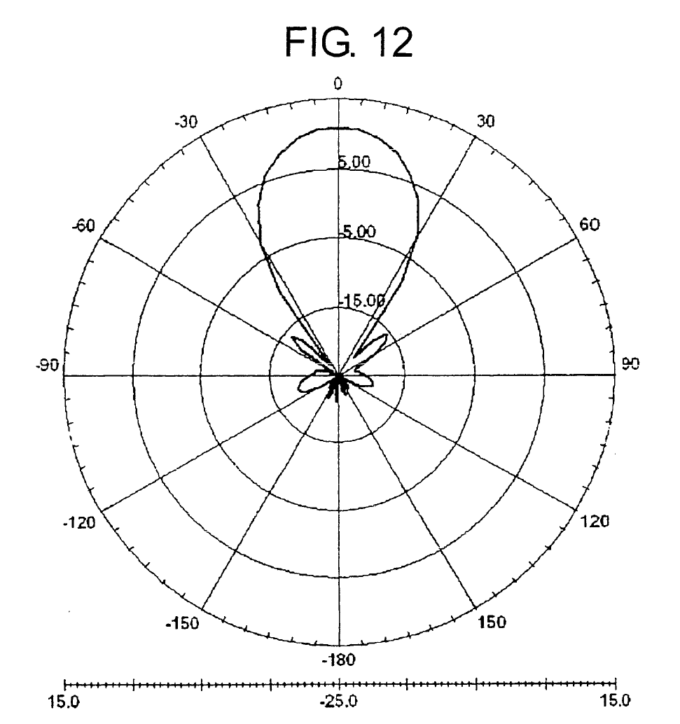

FIG. 13 is a top view showing an arrangement of WAPs provided on a ceiling space almost just over one aisle out of two rows of aisles in the cabin.

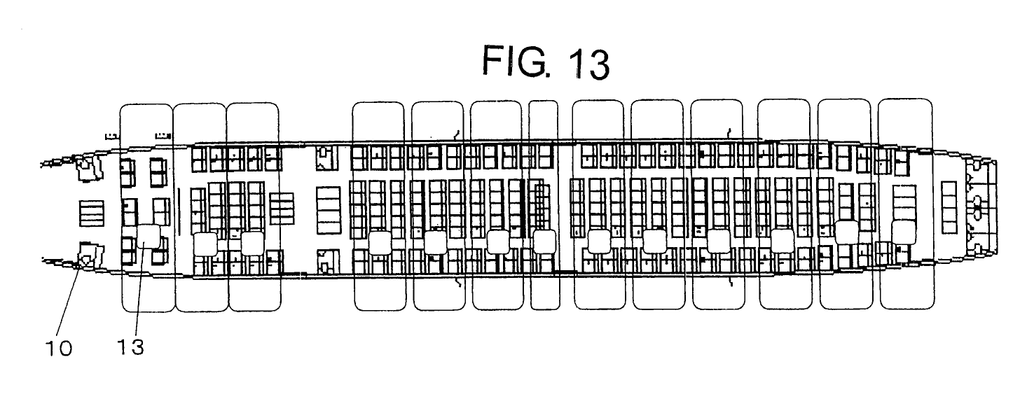

FIG. 14 is a sectional view showing an arrangement of WAPs provided on the ceiling space almost just over one aisle out of two rows of aisles in the cabin.

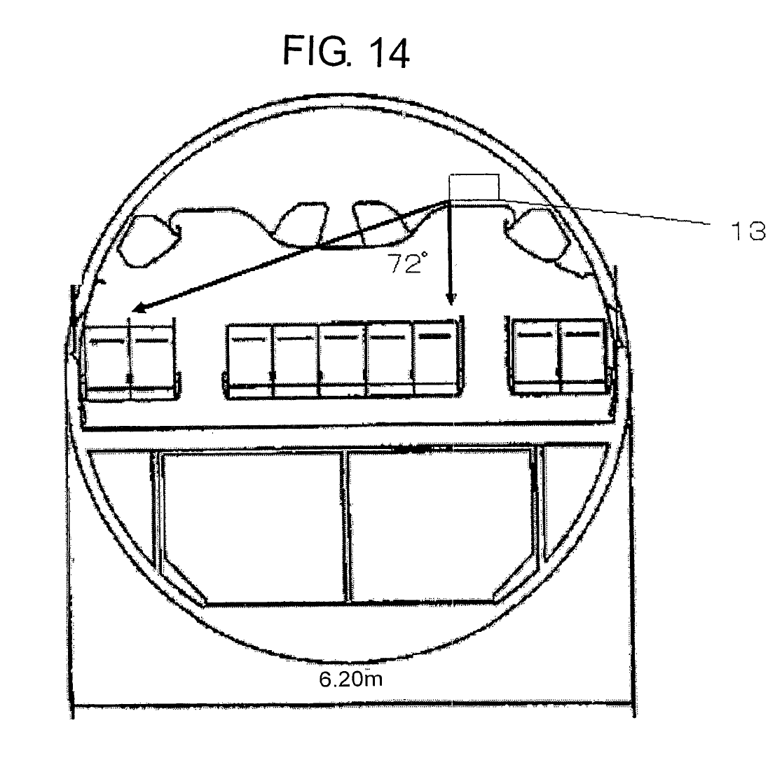

FIG. 15 is a top view showing another arrangement of WAPs provided on the ceiling space almost just over one aisle out of two rows of aisles in the cabin.

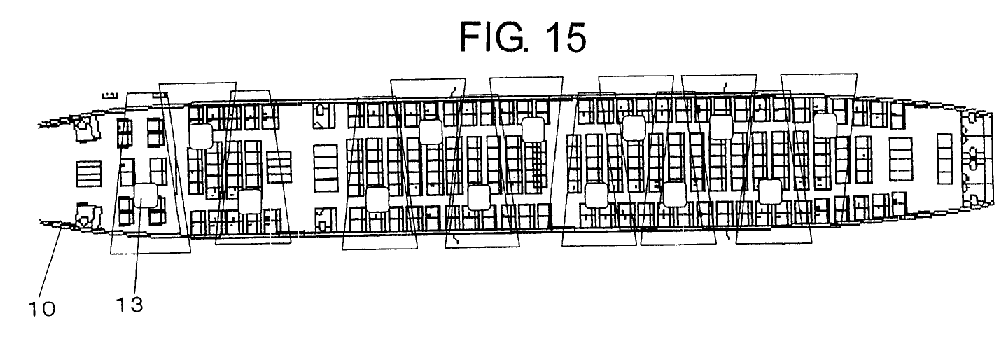

### DESCRIPTION OF REFERENCE NUMERALS

10 cabin
11 server
12 connection cable
13 WAP
14 client terminal
15, 75 antenna device
21 radio module
31 three-way distributor
32 coaxial cable
33 dipole antenna
35 dipole array antenna
36 balun
51 ground pattern

### BEST MODE FOR CARRYING OUT THE INVENTION

Embodiments of the present invention will be explained with reference to the drawings hereinafter.

### First Embodiment

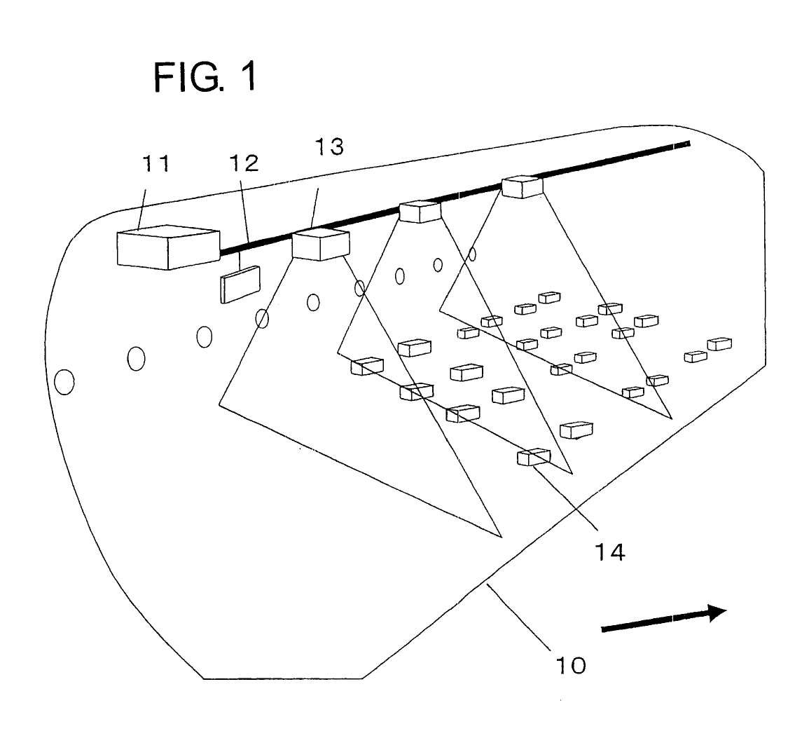

Like the IFE system utilizing a radio communication shown in FIG. 1, an IFE system according to a first embodiment of the present invention includes a server 11, a connection cable 12, a plurality of WAPs 13 to which an antenna device 15 is connected respectively, and a plurality of client terminals 14. The server 11, the connection cable 12, the plurality of WAPs 13 are provided on the ceiling space of the cabin 10 of the aircraft, the bus, the ship, the train, and the like. The server 11 and respective WAPs 13 are connected via the connection cable 12. Also, the client terminal 14 is provided near the passenger's seats respectively. The WAPs 13 and the client terminals 14 have a wireless network interface circuit (not shown) respectively, and can hold a radio communication utilizing a wireless LAN based on IEEE802.11n. That is, the WAPs 13 and the client terminals 14 exchange a radio communication based on the MIMO (Multi Input Multi Output) system. Therefore, the WAPs 13 and the client terminals 14 utilize an array antenna having a plurality of antenna elements.

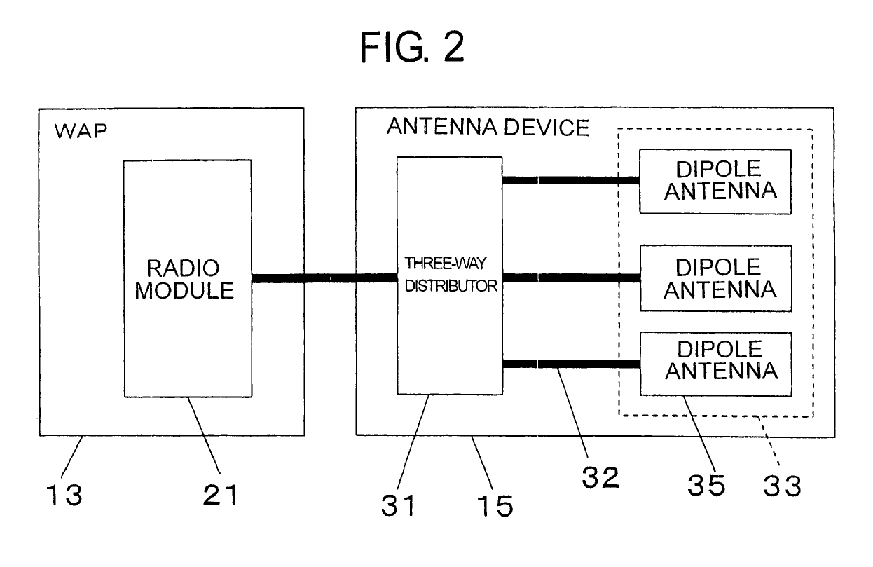

As shown in FIG. 2, the WAP 13 has a radio module 21, and the antenna device 15 has a three-way distributor 31, and a dipole array antenna 33 with three dipole antennas 35. The three-way distributor 31 and the dipole array antenna 33 are connected via coaxial cables 32. When a signal being output from the radio module 21 of the WAP 13 is input into the antenna device 15, the signal is distributed into three in-phase signals by the three-way distributor 31. Three distributed signals are sent to respective dipole antennas 35 via the coaxial cables 32.

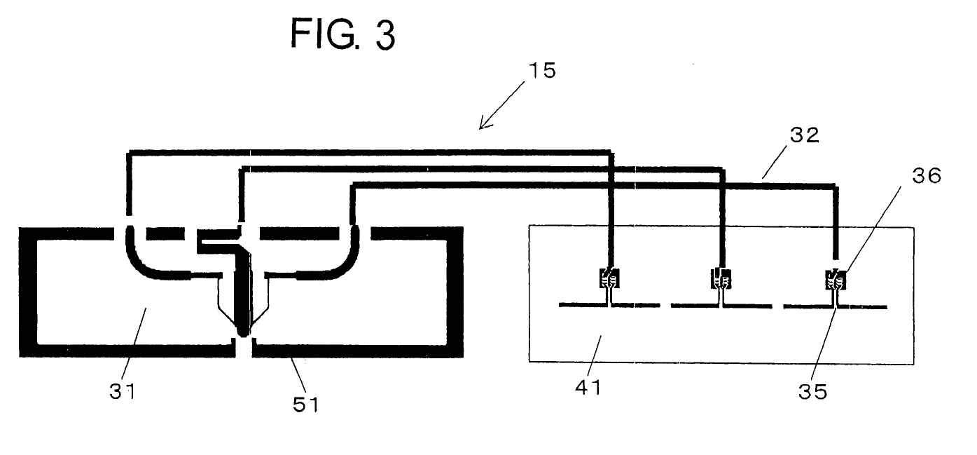

FIG. 3 shows patterns of the three-way distributor 31 and the dipole array antenna 33 that are provided to the antenna device 15 of the first embodiment. As shown in FIG. 3, the three-way distributor 31 and the dipole array antenna 33 are configured on different substrates respectively. Three dipole antennas 35 and three baluns 36 are constructed on a substrate 41 of the dipole array antenna 33. The three-way distributor 31 has one input terminal and three output terminals, and a ground pattern 51 is constructed between respective terminals. Respective output terminals of the three-way distributor 31 are connected to respective dipole antennas of the dipole array antenna 33 via the coaxial cables 32 and the balun 36. In this case, a length of the coaxial cables 32 is adjusted such that a phase difference between the signals being output from three dipole antennas 35 is set to 10 degree or less.

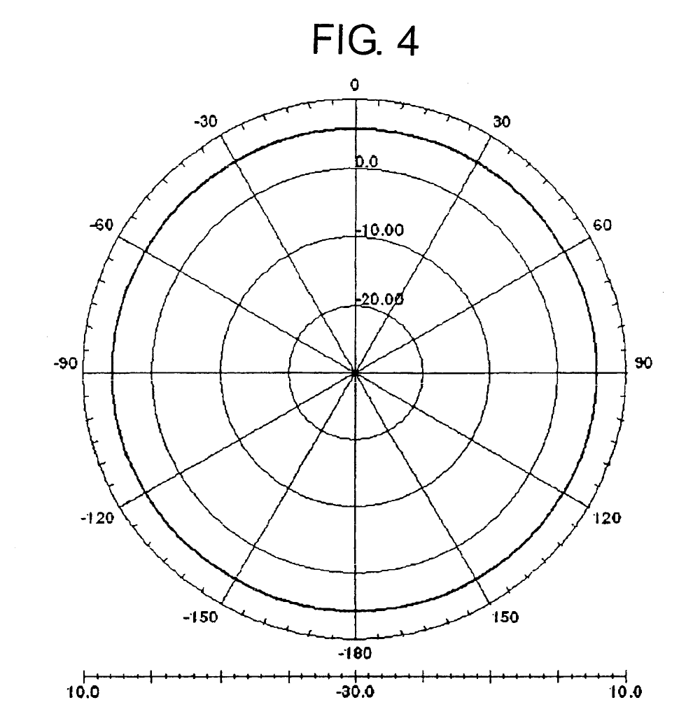

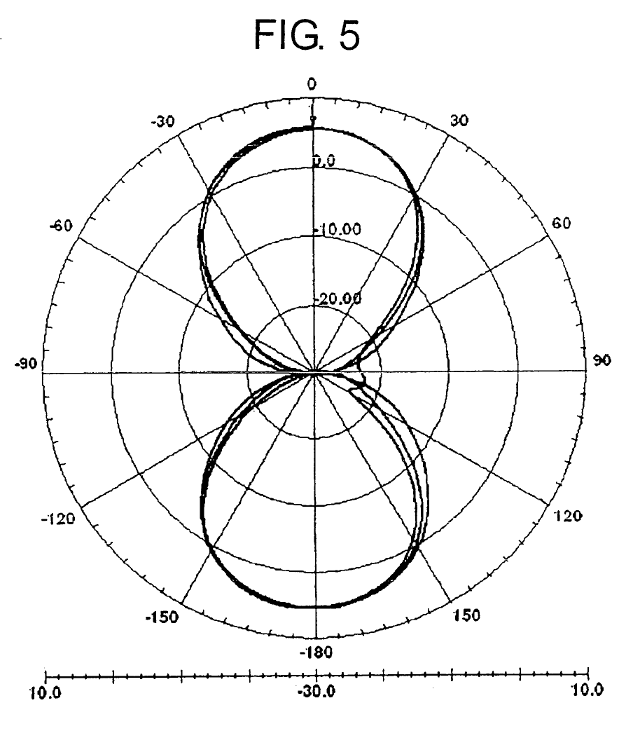

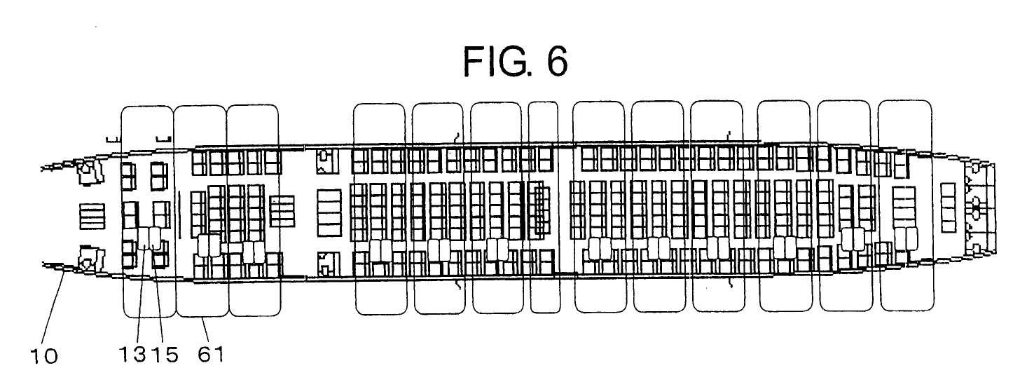

The directivity of the antenna device 15 of the first embodiment is shown in FIG. 4 and FIG. 5. FIG. 4 shows a directivity on a first vertical plane of the antenna device 15, and FIG. 5 shows a directivity on a second vertical plane of the antenna device 15, which intersects orthogonally with the first vertical plane. Here, the antenna device 15 is provided such that the first vertical plane of the antenna device 15 is set in the lateral direction of the aircraft and the second vertical plane is set in the longitudinal direction of the aircraft. Also, as shown in FIG. 6, the WAPs 13 and the antenna devices 15 are provided in the ceiling space almost just over one aisle out of two rows of aisles of the cabin 10.

As shown in FIG. 5, a pattern indicating the directivity of the second vertical plane (the longitudinal direction) has an 8-shaped form, and the directivity is narrow. Therefore, a radio interference with the signal from the adjacent WAP can be avoided by adjusting the sending power of respective WAPs. In contrast, as shown in FIG. 4, the pattern is non-directional on the first vertical plane (the lateral direction). Therefore, as shown in FIG. 6, one WAP 13 and one antenna device 15 covers a zone 61 that contains about three rows of the passenger's seats in the longitudinal direction of the cabin 10. In this case, in order to prevent a radio interference, or the like, a discrete channel that is separated from the channel by three or four channels is assigned to neighboring zones.

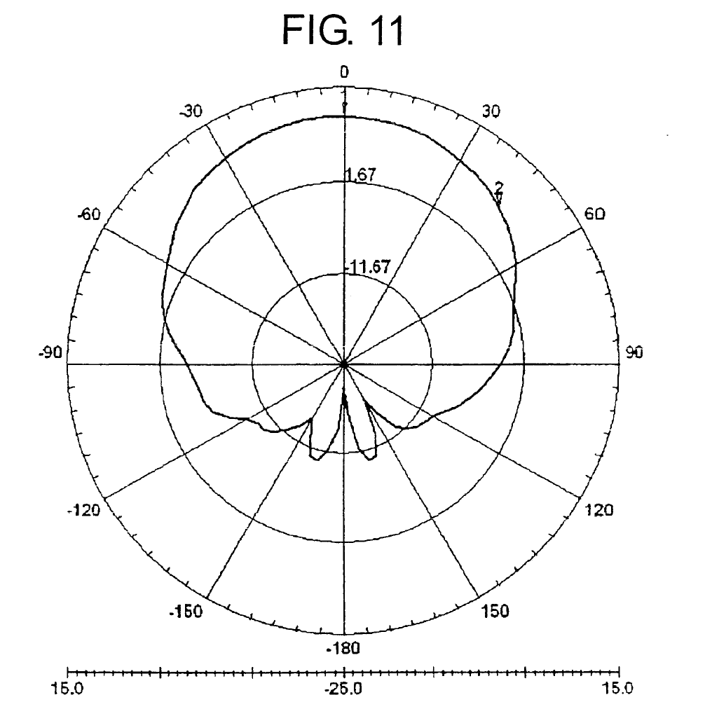

In the present embodiment, the sending power is adjusted such that the client terminal 14 that is most distant from the antenna device 15 in the zone and next the window can also receive the signal at sufficient electric field strength. In this case, since no directivity on the first vertical plane is given in the present embodiment, the client terminal 14 next to the window can receive the signal at sufficient electric field strength, in comparison with the patch antenna whose half-power angle shown in FIG. 11 is about 90 degree.

Also, since the IFE system of the present embodiment is provided in a space at least a part of which is surrounded with a metal, a radio wave radiated from the antenna device 15 is reflected by ceiling, floor, wall, and the like. In the SISO system, such reflected wave becomes a factor in degradation of a communication quality. However, since the MIMO system is utilized in the present embodiment, such reflected wave is utilized positively. In other words, a difference in the path caused by the reflection is utilized positively in the MIMO system. Therefore, like the present embodiment, the antenna device 15 having a plurality of antennas and the MIMO system are used in combination in a space at least a part of which is surrounded with a metal, the characteristics of both systems can be used efficiently.

In the present embodiment, the WAP 13 and the antenna device 15 are constructed as the separate equipment. Alternatively, the antenna device 15 may be provided in a case of the WAP 13.

### Second Embodiment

A different point of an IFE system of a second embodiment from the IFE system of the first embodiment resides in the antenna device. In the first embodiment, the three-way distributor 31 and the dipole array antenna 33, which are provided to the antenna device 15, are constructed on separate substrates respectively. In contrast, in the second embodiment, the three-way distributor 31 and the dipole array antenna 33 are constructed on the same substrate. Also, in the first embodiment, the three-way distributor 31 and the dipole array antenna 33 are connected by the coaxial cable. In contrast, in the second embodiment, the three-way distributor 31 and the dipole array antenna 33 are connected directly.

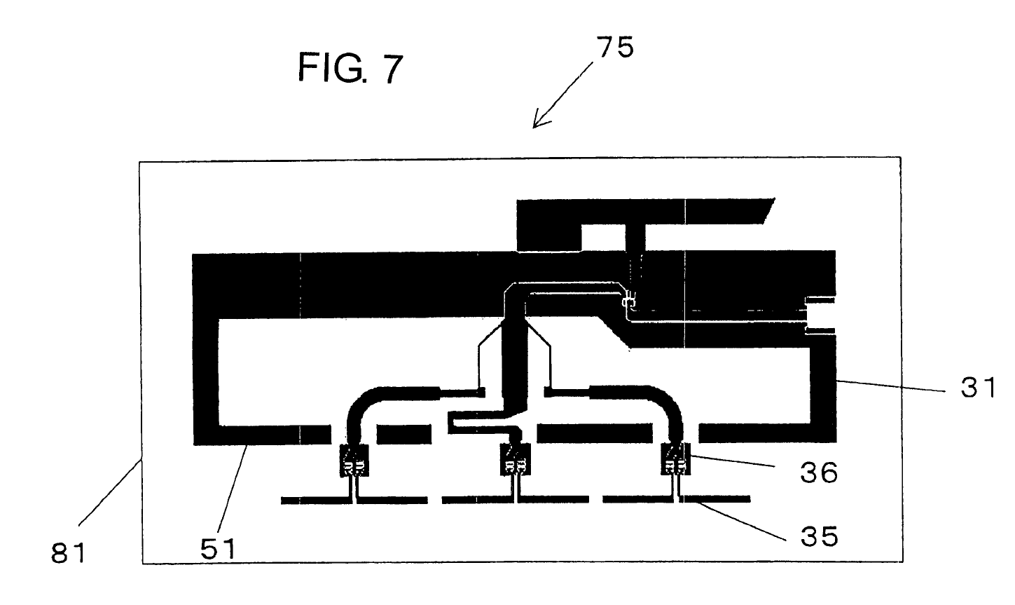

FIG. 7 shows patterns of the three-way distributor 31 and the dipole array antenna 33 that are provided to an antenna device 75 of a second embodiment. As shown in FIG. 7, the three-way distributor 31 and the dipole array antenna 33 are constructed on the same substrate 81. The patterns themselves of the three-way distributor 31 and the dipole array antenna 33 are similar to those of the first embodiment. However, in the present embodiment, the dipole array antenna 33 is constructed such that respective centers (feeding points) of three dipole antennas 35 are provided in a position that is away from an end of the ground pattern 51 of the three-way distributor 31 by an electrical length of about ¼ wave length. For example, when the antenna device 75 responds to a frequency in a 5 GHz band and a Teflon (registered trademark) substrate whose dielectric constant is about 2.1 and which has low loss is used, the dipole array antenna 33 is provided in a position that is away from the end of the ground pattern 51 by about 15 mm.

As described in the present embodiment, when the ground pattern is located in vicinity of the antenna, such ground pattern acts as a parasitic element and gives re-radiation of a radio wave. Also, in the present embodiment, since the dipole antennas 35 and the three-way distributor 31 are separated mutually by a ¼ wave length, a direct radio wave radiated from the dipole antennas 35 and a radio wave re-radiated from the ground pattern 51 cancel each other out. Therefore, the directivity in the direction from the dipole antennas 35 to the three-way distributor 31 shows a null point from which almost no radio wave is radiated. In this case, since the ceiling space of the cabin 10 of the aircraft is occupied by the cables, the ducts, etc., a radio wave is not so much reflected by the ceiling. Therefore, the antenna device 75 is arranged such that the null point side is directed toward the ceiling side.

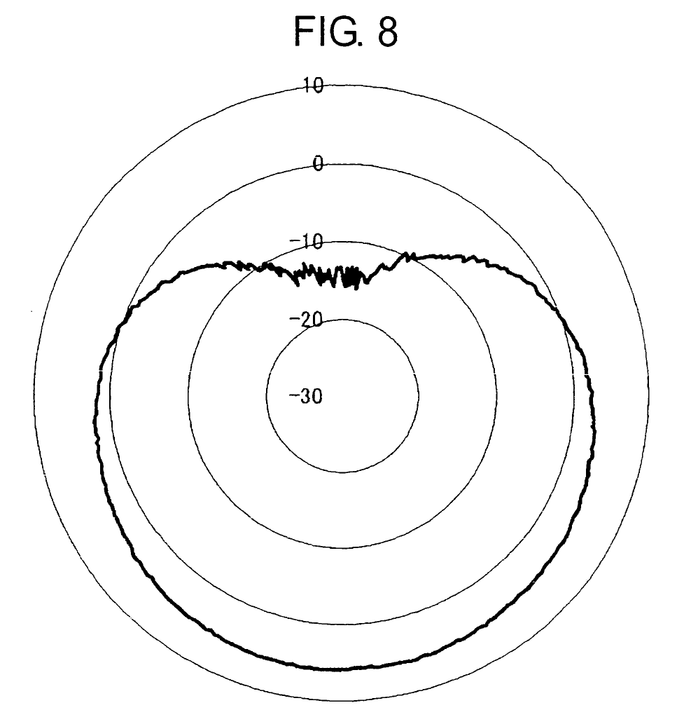

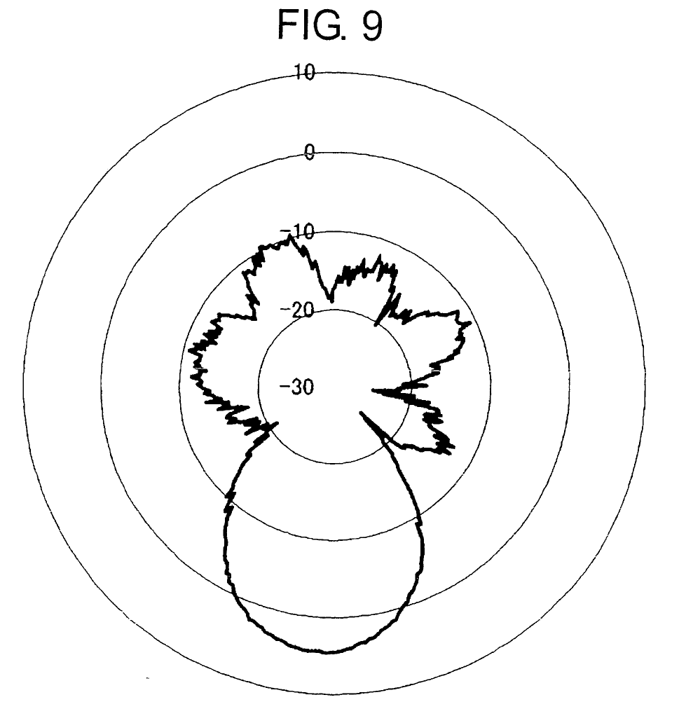

The directivity of the antenna device 75 of the second embodiment is shown in FIG. 8 and FIG. 9. FIG. 8 shows a directivity on a first vertical plane of the antenna device 75, and FIG. 9 shows a directivity on a second vertical plane that intersects orthoganally with the first vertical plane of the antenna device. Here, like the first embodiment, the antenna device 75 is installed such that the first vertical plane is set in the lateral direction of the aircraft and the second vertical plane is set in the longitudinal direction of the aircraft.

As shown in FIG. 9, a radiation pattern on the second vertical plane (the longitudinal direction) has a main lobe extended on the particular direction and has a null point in other directions. Since the directivity is narrow, a radio interference with the signal from the adjacent WAP can be avoided by adjusting the sending power of respective WAPs, like the first embodiment. In contrast, as shown in FIG. 8, a pattern indicating the directivity on the first vertical plane (the lateral direction) has a cardioid shape, and a half-power angle is wide like about 150 degree. Therefore, the client terminal 14 that is most distant from the antenna device 75 and next the window can also receive the signal at sufficient electric field strength.

Also, in the antenna device 75 of the present embodiment, the three-way distributor 31 and the dipole array antenna 33 are connected not via the coaxial cable, or the like but directly mutually. Therefore, stability due to a difference in frequencies used in respective channels can be attained and the production at a low cost can be achieved. Also, there is no need to manage respective lengths of the coaxial cables, which is required in the first embodiment, and therefore a design is facilitated.

In the embodiment explained above, the number of distribution is set to 3, and also the number of dipole antennas that the antenna device has is set to 3. But the numbers are not limited to this mode. Any numbers may be employed if the numbers are in excess of 2. Also, in the above embodiment, as shown in FIG. 6, the case where the WAPs 13 and the antenna devices 15 are provided in the ceiling space almost just over one aisle is explained. But the installing location is not limited to the place just over one aisle, and also the installing area is not limited in the ceiling space.

The present invention is explained in detail with reference to the particular embodiments. But it is apparent for those skilled in the art that various variations and modifications can be applied without departing from a spirit and a scope of the present invention.

This application is based upon Japanese Patent Application (Patent Application No. 2006-294035) filed on Oct. 30, 2006; the contents of which are incorporated herein by reference.

### INDUSTRIAL APPLICABILITY

The antenna device according to the present invention is useful to the antenna that provides good communication quality in any location in the space at least a part of which is surrounded with the metal when such antenna is provided in the space and used in the radio communication system utilizing the MIMO system.

1-4. (canceled)

5. An antenna device provided in a space at least a part of which is surrounded with a metal and used in a radio communication system based on a MIMO system, the antenna device comprising:
a dipole array antenna including a plurality of dipole antennas,
wherein the dipole array antenna is non-directional on a first vertical plane, and a pattern indicating a directivity on a second vertical plane that intersects orthogonally with the first vertical plane has an 8-shaped form.

6. An antenna device provided in a space at least a part of which is surrounded with a metal and used in a radio communication system based on a MIMO system, the antenna device comprising:
a dipole array antenna including a plurality of dipole antennas,
wherein a pattern indicating a directivity on a first vertical plane of the dipole array antenna has a cardioid shape, and a radiation pattern on a second vertical plane that intersects orthogonally with the first vertical plane has a main lobe extended on a particular direction and has a null point in other directions.

7. The antenna device according to claim 5, wherein the space is an internal space of a fuselage of an aircraft.

8. The antenna device according to claim 5, wherein the radio communication system includes an access point and a client terminal, and is used as antennas on a side of the access point.

9. The antenna device according to claim 6, wherein the space is an internal space of a fuselage of an aircraft.

10. The antenna device according to claim 6, wherein the radio communication system includes an access point and a client terminal, and is used as antennas on a side of the access point.
